(19) United States
(12) Patent Application Publication
(10) Pub. No.: US 2025/0236711 A1
(43) Pub. Date: Jul. 24, 2025

(54) METHOD TO IMPROVE 3D PRINTABILITY OF PROTEINS

(71) Applicant: The Governors of the University of Alberta, Edmonton (CA)

(72) Inventors: Roopesh Mohandas Syamaladevi, Edmonton (CA); Sreelakshmi Chembakasseri Menon, Edmonton (CA)

(73) Assignee: The Governors of the University of Alberta, Edmonton, AB (CA)

(21) Appl. No.: 19/032,172

(22) Filed: Jan. 20, 2025

Related U.S. Application Data
(60) Provisional application No. 63/622,105, filed on Jan. 18, 2024.

(51) Int. Cl. B33Y 70/00; B33Y 80/00

(52) U.S. Cl. CPC C08J 3/28; B33Y 70/00; B33Y 80/00

(57) ABSTRACT

A method for preparing a biomaterial gel for three-dimensional printing that includes generating plasma-activated microbubble (PAMB) water by treating distilled water for a first period of time, at a first temperature in a plasma reactor with a feed gas. The PAMB water is applied to a biomaterial to prepare a biomaterial suspension. The biomaterial suspension is then heated at a second temperature for a second period of time and then cooled at a third temperature for a third period of time to form a biomaterial gel from materials such as polypeptide, a protein, a plant protein, a pulse protein, a pea protein, or a fava protein. The PAMB water is generated using non-thermal plasma.

### RELATED APPLICATIONS

This application is a non-provisional application that claims priority benefit of U.S. Provisional Application Ser. No. 63/622,105 filed Jan. 18, 2024; the contents of which are hereby incorporated by reference.

### FIELD OF THE INVENTION

The present invention relates to three-dimensional (3D) printing of biomaterials, and more particularly to a method of improving 3D printability and other functional properties of proteins with the use of plasma activated water bubbles.

### BACKGROUND OF THE INVENTION

Three-dimensional (3D) printing, also known as additive manufacturing technology, is a construction method that relies on digital models that are built through computer-aided design software to produce 3D objects using a 3D printer by stacking materials layer-over-layer in a three-dimensional space. The possibilities of personalization, customization, and construction of complex shapes have led to an increase in scientific interest in 3D food printing. The advantages of precise nutrition control and reduction of food wastage further increased the popularity of this technology.

One of the emerging and potentially ground-breaking applications is the development of 3D-printed scaffolds for cell culture and cellular agriculture. Other important applications are the development of meat and cheese analogues, encapsulation of bioactive compounds and their controlled release by 3D-printed food product development. The commonly explored technology is extrusion printing, which works on the principle of extruding the “food inks” through a fine nozzle to form a layer-by-layer structure on the printing bed. There are multiple material properties, which are important in 3D food printing. These include printability or extrudability and structural and storage stability. The printability or extrudability is related to the viscosity of the ink. The structural and storage stability is related to the compressive strength and rheological properties of the food ink.

Plant protein gels can be possibly used for 3D food printing applications, including the preparation of scaffolds for cellular agriculture plant-based meat or cheese analogs, encapsulation, and delivery of bioactive and nutritional compounds. However, as a natively non-extrudable food material, pulse proteins have not been utilized as a major component in 3D printing.

Non-thermal (cold) plasma is an emerging technology that is generated by an electrical discharge by utilizing a variety of input gases. Plasma produces reactive oxygen species (ROS) and reactive nitrogen species (RNS). Cold plasma treatments have been shown to improve protein gelation. Plasma generation and activation in underwater bubbles is a recent development in plasma application. Confinement of gaseous plasma inside the bubbles, followed by the introduction of these bubbles into the water, results in better agitation and mixing of plasma reactive species with water and their improved interactions with the target molecules.

Thus, there exists a need for a method of improving the printability and other functional properties of pulse proteins and other biomaterials for 3D-printed food product development.

### SUMMARY OF THE INVENTION

The present invention provides a method of preparing a biomaterial gel for three-dimensional printing that includes generating plasma-activated microbubble (PAMB) water by treating distilled water for a first period of time, such as 10 to 45 minutes, at a first temperature, such as room temperature of 15° C. to 25° C., in a plasma reactor with a feed gas. Next, the PAMB water is applied to a biomaterial to prepare a biomaterial suspension. The biomaterial suspension is subsequently heated at a second temperature for a second period of time and then cooled at a third temperature for a third period of time to form a biomaterial gel. According to embodiments, the biomaterial is a polypeptide, a protein, a plant protein, a pulse protein, a pea protein, or a fava protein.

According to embodiments, the PAMB water is generated using non-thermal plasma. According to embodiments, generating the PAMB water includes treating the distilled water continuously. According to embodiments, plasma reactor is a bubble spark discharge reactor. According to embodiments, feed gas is a mixture of 80% argon and 20% air (ARG80) or a mixture of 90% argon and 10% air (ARG90). According to embodiments, at a fixed flow rate, such as 0.1 to 10 SLPM.

According to embodiments, applying the PAMB water to a biomaterial includes mixing the biomaterial with the PAMB water by stirring to prepare the biomaterial suspension. According to embodiments, the stirring occurs within 5 minutes of the PAMB generation. According to embodiments, the biomaterial suspension is stirred for 45 to 90 minutes at room temperature of 15° C. to 25° C. followed by 45 to 90 minutes at 4±2° C.

According to embodiments, the heating of the biomaterial suspension occurs in a hot water bath. According to embodiments, the second temperature is 70° C. to 95° C. and the second time period is from 45 to 90 minutes.

According to embodiments, cooling the heated biomaterial suspension occurs in an ice-water bath. According to embodiments, the third temperature is 4±2° C. and the third time period is 10 to 45 minutes.

According to other inventive embodiments, the method additionally includes placing the biomaterial suspension in a 3D printer syringe and optionally tapping the 3D printer syringe to remove air bubbles from the syringe.

### BRIEF DESCRIPTION OF THE DRAWINGS

The present invention is further detailed with respect to the following figures that depict various aspects of the present invention.

FIG. 1 is a schematic depiction of an experimental setup for the preparation of plasma activated microbubble water, the preparation of pea protein isolate-plasma activated microbubble water suspension (PPI-PAMB suspension), and the preparation of PPI-PAMB gel inks for 3D printing according to embodiments of the present invention;

FIG. 2A is a graph showing the frequency dependence of storage modulus (G′) and loss modulus (G″) of PPI-PAMB for gels with different feed gas combinations when heating is done at 85° C. for 30 min, followed by cooling in an ice water bath for 30 min;

FIG. 2B is a graph showing the frequency dependence of storage modulus (G′) and loss modulus (G″) of PPI-PAMB for gels with different feed gas combinations when heating is done at 85° C. for 60 min, followed by cooling in an ice water bath for 30 min;

FIG. 3A is a graph showing the frequency dependence of tan δ of PPI gels with different feed gas combinations when heating is done at 85° C. for 60 min followed by cooling in an ice water bath for 30 min;

FIG. 3B is a graph showing frequency dependence of complex viscosity of PPI gels with different feed gas combinations when heating is done at 85° C. for 60 min followed by cooling in an ice water bath for 30 min;

FIG. 4 shows top and side views of several 3D printed PPI gels gelled at 85° C. for 30 and 60 min respectively, followed by cooling in ice water bath for 30 minutes, wherein the images are captured within 5 min after completion of 3D printing;

FIG. 5 shows perspective views storage deformation images of several 3D printed PPI gels gelled at a temperature of 85° C. for 60 min, followed by cooling at 4C for 30 min, wherein the images are taken upon storage for 24 and 72 h, respectively;

FIG. 6A is a graph showing the change in length dimensions of 3D printed PPI-DW and PPI-PAMB gels upon storage up to 72 h;

FIG. 6B is a graph showing the change in diameter dimensions of 3D printed PPI-DW and PPI-PAMB gels upon storage up to 72 h;

FIG. 7 is a photograph of a 3D printed fava bean protein gel made with PAMB where gels were prepared by heating at 85° C. for 30 minutes; and

FIG. 8 is a photograph showing 3D printed fava bean protein gel made with distilled water, where gels were prepared by heating at 85° C. for 30 minutes.

### DESCRIPTION OF THE INVENTION

The present invention has utility as a method of improving the printability and other functional properties of pulse proteins and other biomaterials for 3D-printed food product development.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

The present invention provides a method to improve the 3D printability and other functional properties, such as rheological properties, structural stability during storage, and compressive strength, of biomaterials including pulse proteins (e.g., pea protein, fava bean protein etc.). This method uses non-thermal plasma activated water bubbles to prepare strong pulse protein materials/gels with better printability, rheological properties, and compressive strength, dimensional stability during storage, compared to those prepared using distilled water. The printability and other functional properties are essential for 3D printing applications of plant proteins and biomaterials. This process can be scaled up easily for continuous production of 3D printable biomaterials and plant proteins.

The present invention provides a method of preparing a biomaterial gel for three-dimensional printing that includes generating plasma-activated microbubble (PAMB) water by treating distilled water for a first period of time, such as 10 to 45 minutes, at a first temperature, such as room temperature of 15° C. to 25° C., in a plasma reactor with a feed gas. Next, The PAMB water is applied to a biomaterial isolate to prepare a biomaterial isolate suspension. The biomaterial isolate suspension is then heated at a second temperature for a second period of time and then cooled at a third temperature for a third period of time to form a biomaterial gel. According to embodiments, the biomaterial is a polypeptide, a protein, a plant protein, a pulse protein, a pea protein, or a fava protein.

According to some inventive embodiments, the PAMB water is generated using non-thermal plasma. According to other inventive embodiments, generating the PAMB water includes treating the distilled water continuously. According to still other inventive embodiments, plasma reactor is a bubble spark discharge reactor. According to embodiments, feed gas is a mixture of 80% argon and 20% air (ARG80) or a mixture of 90% argon and 10% air (ARG90). According to embodiments, at a fixed flow rate, such as 0.1 to 10 SLPM.

According to some inventive embodiments, applying the PAMB water to a biomaterial isolate includes mixing the biomaterial isolate with the PAMB water by stirring to prepare the biomaterial isolate suspension. According to other inventive embodiments, the stirring occurs within 2 minutes of the PAMB generation. According to still other inventive embodiments, the biomaterial isolate suspension is stirred for 45 to 90 minutes at room temperature 15° C. to 25° C. followed by 45 to 90 minutes at 4±2° C.

According to some inventive embodiments, the heating of the biomaterial isolate suspension occurs in a hot water bath. According to other inventive embodiments, the second temperature is 70° C. to 95° C. and the second time period is 45 to 90 minutes.

According to some inventive embodiments, cooling the heated biomaterial isolate suspension occurs in an ice-water bath. According to other inventive embodiments, the third temperature is 4±2° C. and the third time period is 10 to 45 minutes.

According to some inventive embodiments, the method additionally includes placing the biomaterial isolate suspension in a 3D printer syringe and optionally tapping the 3D printer syringe to remove air bubbles from the syringe.

According to some inventive embodiments, pea protein isolate (PPI) and fava bean protein, which are natively non-extrudable food ingredients, which are generally unsuitable for 3D printing achieve better 3D printing properties by the application of plasma-activated microbubble (PAMB) water and thermal gelation methods. The rheological and mechanical properties indicate that PPI suspension prepared using PAMB, followed by gelation at a heating temperature of 85° C. for 60 min, and cooling at 4° C. for 30 min; results in the best 3D printability. The PAMB water generated using a mixture of 80% argon and 20% air (ARG80) as well as 90% argon and 10% air (ARG90) is used to prepare 3D printed PPI gels with greater structural stability. The improved structural stability of these 3D printed PPI gels is at least in part due to the enhanced rheological and mechanical properties, which are related to the optimal reactive oxygen and nitrogen species concentration in PAMB prepared using ARG80 and ARG90. The ideal gelation, gel strength, and 3D printability of 3D printed gels may correspond to the presence of both ROS and RNS, rather than either one. Overall, it is shown that the application of PAMB in improving the structural properties of PPI and its 3D printability.

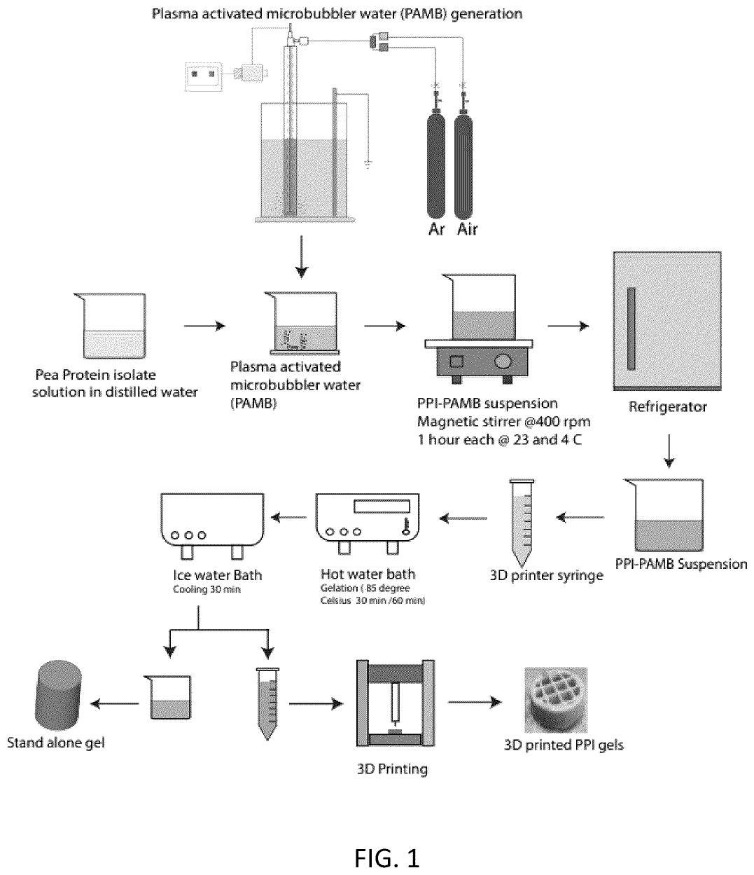

The method begins by producing plasma activated microbubbles (PAMB) in water. According to some inventive embodiments, PAMB in water are produced using a bubble spark discharge reactor. The reactor, as shown in FIG. 1 includes a stainless-steel rod of 5 mm diameter, which serves as the high-voltage electrode and is encased into a quartz tube, which according to other inventive embodiments has a 15 mm inner diameter. Another stainless steel rod with a 5 mm diameter is used as a ground electrode. Both the quartz tube encasing the high voltage electrode and the ground electrode are submerged into the glass beaker containing distilled water in such a manner that they touched the bottom of the beaker. The high voltage is supplied to the electrode through a transformer and plasma generator capable of discharging power of 0-400 W at an AC frequency of 50 Hz-3000 Hz. The gas flow into the reactor is controlled by a mass controller and is fixed at 1 SLPM (Standard Liter Per Minute). The reactor is operated at fixed parameters in all experiments (resonance frequency—60 kHz; discharge frequency—1000 Hz; duty cycle—66 usec; input voltage—150 V).

The PAMB water is prepared by treating 100 ml distilled water continuously for 30 min in a 250 ml beaker at room temperature (15° C.-25° C.) using the bubble spark discharge reactor, with different combinations of air and argon as feed gases. The combinations of gases used are 100% argon, 100% air, 90% argon along with, 10% air, and 80% argon along with, 20% air, at a fixed flow rate of 1 SLPM. The temperature of PAMB after 30 min of treatment increases to 40°-43° C. (FIG. 1A).

Concentrations of Reactive Oxygen Species (ROS) and Reactive Nitrogen Species (RNS) in the plasma activated microbubble water are estimated using test kits (CHEMetrics, LLC, Midland, VA, USA) as per the procedure outlined in the test kits.

The prepared PAMB (80 g) is mixed with pea protein isolate (PPI, 20 g) to produce pea protein suspension (20 solid wt. %) with magnetic stirring within 2 min of PAMB preparation. The suspension is then stirred for 1 h (400 rpm) at room temperature (˜23° C.), followed by 1 h stirring (400 rpm) at 4° C. (FIG. 1B). Depending upon the gas combinations used, each suspension is labelled as ARG100 (100% argon only), AIR100 (100% air only) ARG90 (90% argon+10% air), and ARG80 (80% argon+20% air). The control sample is prepared by mixing distilled water (80 g) with PPI (20 g) and the sample is labelled as DW, as shown in FIG. 1.

A protein isolate gel is then prepared. According to some inventive embodiments, the stirred PPI suspension is transferred to a 35 ml 3D printer syringe, tapped to remove air bubbles, and incubated for 30 or 60 min in a hot water bath maintained at 80° C., 85° C. and 90° C. After incubation at specific temperatures for selected times, the samples are transferred to an ice-water bath maintained at 1° C. ±0.5° C. for cooling for 30 min. Then, the syringes are taken out of the ice water bath, closed with a rubber cork, and mounted into the barrel connected to the 3D Printer for immediate printing. For characterization studies, the same procedure of gelation is followed using a 10 ml glass beaker instead of a 35 ml 3D printer. Upon complete cooling after gelation, the beaker is inverted, and the PPI gels are removed. Gelation is visually determined by the stand-alone nature of the gels, as in FIG. 1. The formed gels are stored at 4° C. for 12-16 h before characterization. The gels from PPI suspension prepared using PAMB are referred to as PPI-PAMB gels herein.

The rheological properties of the PPI gels are tested on a TA Discovery HR-3 rheometer (TA Instruments, New Castle, DE, USA). The rheometer is equipped with a parallel plate geometry with a diameter of 40 mm and a gap of 1 mm. The gel sample is placed on the rheometer plate for the frequency and amplitude sweep test. An amplitude sweep is performed in the 0.01-1% shear strain range at a frequency of 1 Hz to determine the linear range. Frequency sweep is conducted on gels compressed to 90% of their original height. Frequency sweeps are performed to determine the storage modulus G′, loss modulus G″, loss angle tan δ, and complex viscosity at oscillation frequency from 0.1 to 100 rad/s by applying a constant strain of 0.5% at 23° C. All rheological measurements are performed within the identified linear viscoelastic region at a strain value of 0.5%.

During the oscillatory shear test, the rheometer measures the amplitude of the applied stress and the amplitude of the resulting strain at each angular frequency (@). The complex modulus (G), which combines the elastic and viscous properties of the gel, can be calculated as the ratio of the stress amplitude to the strain amplitude at each frequency. The complex viscosity (n*) can be calculated as the ratio of the complex modulus and angular frequency.

An Instron 5967 universal testing machine (Instron Corp., Norwood, MA, USA) equipped with a 50 N load cell is employed in testing the mechanical properties of the PPI gels. Each sample with cylindrical geometry (20 mm diameter and 25 mm height; measured using a ruler) is compressed to 70% strain, with a deformation rate of 1 mm/min at room temperature of 15° C. to 25° C. The tests are conducted in triplicate. The stress-strain curve is obtained using the testing machine software to calculate three parameters: a). Young's Modulus (which is determined by the tangent slope of the preliminary linear stress-strain response), b). Compressive Strength (which is the maximum compressive stress attained), and c). Compressive Strain at break (which is the compressive strain value at maximum strength).

The FoodBot 3D-Printer (ShiyinTech, Hangzhou, China) is used for the 3D printing of PPI gels. Based on the principle of micro-extrusion, this 3D printer has an operating system that determines the entire printing process by controlling a motor-driven plunger and cartridge that extrudes the sample for printing. The user interface screen of the printer enables the control of the basic operations, such as initiation and termination of 3D printing, network connections, selection of the 3D model, printing temperature, and position of the plunger and cartridge.

For 3D printing, a 3D cylinder model of 10 mm height and 40 mm diameter is designed using Tinkercad® (Autodesk Inc., San Francisco, CA, USA). The created 3D cylinder model is then loaded into Cura Software (Version 15.02.06, Ultimaker, Geldermalsen, Netherlands), which sliced the model.STL file into layers and generated a G-code that can be detected by the 3D printer to print the physical object. This G-code is introduced into the 3D printer by an external USB to facilitate the 3D printing of the cylinder model. The syringes containing the PPI gels are loaded into a temperature-controlled cartridge (20 to 23° C.) and 3D printed in accordance with the following printing conditions: 1.2 mm nozzle diameter, 1 mm layer height, solid bottom layer with 100% infill density and other layers with 50% infill density, rectilinear infill pattern, 20 mm/s speed, and 100% flow rate. The printed 3D images are photographed from different angles immediately after the completion of 3D printing.

The vertical length and the diameter at the bottom of the 3D printed PPI gels are measured. The measurement is obtained using a ruler while placing the sample on the parchment paper on which it is printed. Measurements are taken at constant intervals, i.e., 0 (immediately after printing), 24, 48 and 72 h. The 3D printed gels are stored in airtight containers at ˜4° C. The tests are conducted in triplicate.

The physicochemical characterization of PAMB water produced with different gas concentrations, including pH, oxidation-reduction potential (ORP), and reactive species, indicates the formation of reactive oxygen and nitrogen species (RONS) as described in Table 1.

The production of PAMB water is essentially by the transfer of RONS from plasma to distilled water through microbubbles. Some of the chemical reactions involved in the formation of RONS are detailed below:

O₂+O→O₃ (1)

OH+O→HO₂+O₂ (2)

HO·+HO·→H₂O₂ (3)

NO+·OH→NO₂ (4)

NO₂+·OH→NO₃+H (5)

Ozone, the strongest oxidizing agent and one of the long-lived ROS in plasma is generated in the gaseous phase (Eq 1) and dissolved in water. The feed gas mixture has a significant impact (p<0.05) on the concentration of ozone in PAMB water. For instance, the highest concentration of ozone (17±3 ppm) is observed when AIR100 and ARG90 are used as the feed gas. The lowest ozone concentration is observed when ARG100 and ARG80 are used.

Hydrogen peroxide (H₂O₂) is another major long-lived ROS in plasma. The H₂O₂ is formed by combining OH radicals, as indicated in the equation 3. Similar to the ozone species, the concentration of H₂O₂ also is significantly (p<0.05) influenced by the feed gas mixture, however, H₂O₂ concentration is the highest when ARG100 (74±2 ppm) is used. When other feed gas combinations with argon, such as ARG90 and ARG80 are used, the H₂O₂ concentrations decreases with a decrease in argon gas concentration. This observation is further substantiated by the lowest H₂O₂ concentration when AIR100 is used. These results indicate that the quantities of reactive species in plasma activated solutions depend upon the feed gases utilized for plasma generation.

TABLE 1
Physicochemical characterization of PAMB water.

| PAMB | Ozone | Peroxide | Nitrite | Nitrate | | ORP |
|---|---|---|---|---|---|---|
| Samples | (ppm) | (ppm) | (ppm) | (ppm) | pH | (mV) |
| AIR100 | 17.9 ± 2.9^{a} | 18.7 ± 5.8^{d} | 4.71 ± 3.70 a | 300 ± 18 ^{a} | 2.77 ± 0.01 a | 514 ± 9 ^{a} |
| ARG80 | 4.83 ± 1.30 b | 21.3 ± 1.2 ^{c} | 1.13 ± 0.10^{b} | 257 ± 35 ^{b} | 2.77 ± 0.02 a | 509 ± 6 ^{a} |
| ARG90 | 13.5 ± 4.2 ^{a} | 33.9 ± 2.9 ^{b} | 1.17 ± 0.20 b | 161 ± 7^{c} | 2.83 ± 0.01 a | 472 ± 2 ^{b} |
| ARG100 | 4.31 ± 2.40 cb | 74.0 ± 2.1 ^{a} | 1.1 ± 0.0 ^{b} | 67.0 ± 0.2 ^{d} | 2.75 ± 0.01 a | 356 ± 16 ^{c} |

PAMB is produced with different gas combinations as feed gas mixture, measured indirectly after production. Values are expressed as the mean±standard deviation of three replicates. Alphabets a,b,c,d within the same column indicate values that are significantly different (p<0.05).

The presence of nitrate and nitrite indicates the generation of RNS in the PAMB water, produced through the dissolution of nitric oxide in gaseous plasma discharge (Equation 4 and 5). The results of the characterization experiment indicate that nitrate concentration is significantly dependent (p<0.05) on the feed gas combination. The nitrate species concentration is the highest when AIR100 (300 ppm) is used, and it decreased with an increase in argon concentration in the gas mixture. For instance, the nitrate concentration is 257 ppm when ARG80 is used, while it is 161 ppm when ARG90 is used. The lowest concentration of nitrate (68 ppm) in PAMB is observed when ARG100 is used. Nitrite concentration is independent (p>0.55) of the % of air, in the case of feed gases with argon and air combination.

The pH of PAMB water produced with different gas combinations is highly acidic, with no significant correlation with the gas combination. The ORP of PAMB waters are considerably different, with PAMB prepared using AIR100 and ARG80 exhibited the highest ORP of 514±9 and 509±6 mV, respectively. The ORP is considerably low for ARG90 (472±2 mV) and is the lowest for ARG100 (356±16 mV).

The characterization results indicate that the RONS concentrations in PAMB are the highest when AIR100 is used as the feed gas except for H₂O₂. The H₂O₂ concentration is the highest when ARG100 is used as the feed gas. When argon is utilized as the feed gas, there is a substantial increase in the generation of ·OH species, due to electronic dissociation with long-lived species. This increased presence of the ·OH results in an increased quantity of hydrogen peroxide as the secondary species.

The concentrations of RONS in PAMB are higher when ARG80 and ARG90 are used as the feed gases in comparison to when ARG100 is used. Since the structure and functional properties of PPI are impacted by the concentration of RONS in PAMB. According to some inventive embodiments, ARG80 and ARG90 would have a higher impact on gelation properties than ARG100.

Preliminary trials are conducted to determine the most suitable concentration of PPI to facilitate gelation. Even though the minimum concentration required for heat-induced gel formation for PPI at near neutral pH is 16%, these gels are characterized by immediate deformation upon application of small force (O'Kane et al., 2005). A protein concentration of 18% is commonly used for gelation experiments, but even at this concentration, the PPI suspension does not form strong stand-alone gels. The PPI suspension prepared with distilled water at 20 wt %, produces a structure with gel-like properties; however, it does not hold shape and is not stable. The PPI suspension (20 wt. %) prepared with PAMB water treated AIR100 as the feed gas produces near stand-alone gels when heated at 85° C. for 30 min. With the increase in heating time to 60 min, the PPI gels formed are stand-alone gels, which do not deform even after applying a small force with a glass rod.

The gels prepared using PPI-PAMB are more stable and stronger when argon is used in combination with air as the feed gas for PAMB water production. With the feed gas combinations of 80% argon and 20% air, the PPI-PAMB gels formed are stand-alone gels, even after shorter heat gelation at 85° C. for 30 min. When the heating time is increased to 60 min, stand-alone gels with better structure and stability are formed. Similar observations are made when the concentration of argon is further increased to 90 and 100%.

Low pH of the PAMB water influences the gelation properties of pea protein. As indicated in Table 1, all the PAMB water samples are highly acidic, while DW is in a pH of 7.0, before the addition of PPI. In the case of PAMB water, the PPI suspensions are essentially prepared in an acidic medium, below the isoelectric point of pea protein. This leads to a reduced solubility in the initial few minutes of agitation, indicating that there is some protein aggregation, due to the electrostatic protein-protein interactions. Upon continuous agitation, the solubility of PPI increases, leading to a homogeneous solution at the end of the stirring process. The final pH of all PPI suspension samples is near neutral at the end of 2 h stirring (6.75-6.9), with no statistical significance between samples. However, the PPI-PAMB suspensions have visibly higher viscosity than PPI-DW suspensions. Hence, there is some initial protein aggregation in PPI suspension prepared from acidic PAMB water, which in turn positively impacts the gelation properties upon undergoing thermal gelation.

During thermal gelation, the weak non-covalent bonds such as hydrogen bonds and electrostatic interactions, are disrupted, causing protein denaturation, which in turn leads to the unfolding of protein chains and exposure of hydrophobic regions (Zhang et al.,2019). This in turn leads to protein-protein interactions, such as hydrophobic and electrostatic interactions, which cause the formation of protein aggregates. A 3D network structure is formed with an increase in the number of protein aggregates. This structure of protein aggregates forms a gel-like network, trapping water and other components. This results in the retention of moisture and the formation of a gel structure (O'Kane et al., 2005).

Direct application of ACP treatment results in a marked improvement in the gelation properties of pea protein (Zhang et al., 2019). With the ACP treatment, the tertiary structure of pea protein is partially unfolded. Reactive oxygen species and reactive nitrogen species generated by the ACP cause oxidation of the unfolded protein, increasing the number of exposed free sulfhydryl groups and disulfide bonds. The gel network formed by pea protein during cold plasma treatment is stabilized by hydrogen bonding, which is crucial for its stability (Zhang et al., 2021). Since ACP has such a marked effect on pea protein gelation, a similar improvement in gelation properties are observed with the application of indirect cold plasma treatment through plasma activated water. Similar mechanisms including protein unfolding and hydrogen bond formation by the interaction of water molecules with the exposed-SH groups are some reasons behind a marked effect on the gelation of pea proteins when PAMB-PPI suspension is utilized.

This observation on the effect of plasma activated water on protein structure is also in corroboration with the study that indicates that the application of plasma activated water increases the aggregation, strength, and water-holding capacity of chicken myofibrillar protein, which otherwise exhibited poor gelation qualities (Qian et al., 2021). Treatments using PAMB and plasma activated water is considered superior to direct plasma treatment when it comes to protein functionality improvement because direct plasma treatment induces severe oxidation of protein molecules (Qian et al., 2021). Moreover, plasma activated water treatment is more uniform, with better interactions between protein molecules and reactive species, avoiding excessive oxidation of proteins (Bermudez-Aguirre, 2019b).

The G′ indicates the ability of the material to store energy elastically, while G″ indicates the nonideal part of the gel network, which is formed by dangling or free ends able to dissipate energy (Zhang et al., 2022). Essentially, G′ or G″ value represents the solid-like or liquid-like properties of a sample, respectively, and a comparison of both indicates the viscoelastic behavior of the sample. The tan d is a measure of the ratio between the viscous and elastic properties of a material. In a perfectly elastic material, the value of d is equal to zero and for perfectly viscous materials, the value of d is equal to 90°.

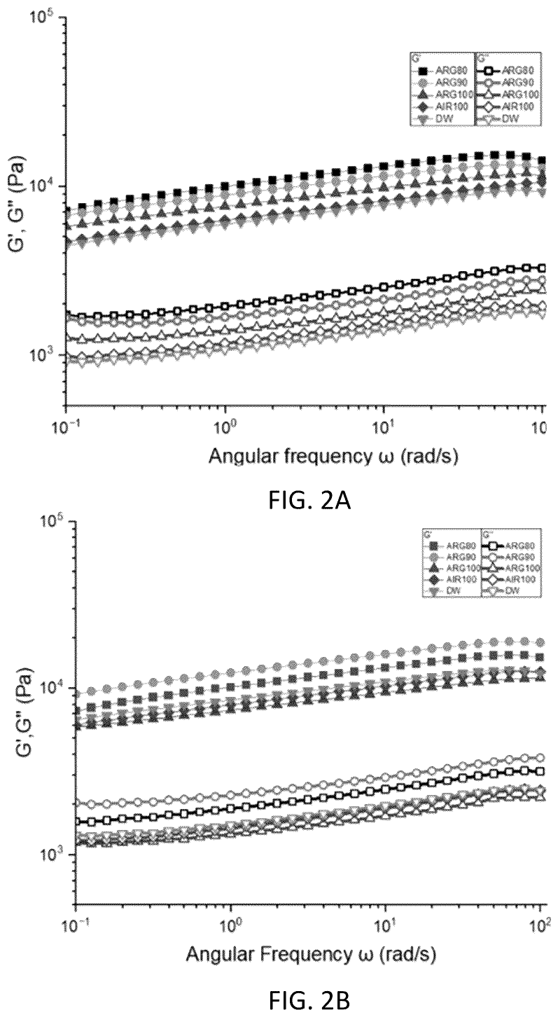

All the tested PPI gel samples display prominent G′>G″ over the tested frequency range of 1 to 100 rad/s, parallel to each other, and mostly frequency independent at all time-temperature combinations, indicating a clear elastic behavior and strong gel-like properties, as shown in FIG. 2. For the samples which are heated at 85° C. for 30 min, ARG80 has the highest G′ and G″ when used as the feed gas, closely followed by ARG90 and ARG100, as shown in FIG. 2A.

A power law may be used to fit G′ and G″ with angular frequency (Moreno et al., 2020). The following equations can be applied.

$${G}^{′} = {G}_{0}^{′} \cdot {ω}^{{n}^{′}} \qquad ( 6 )$$

$${G}^{′′} = {G}_{0}^{′′} \cdot {ω}^{{n}^{′′}} \qquad ( 7 )$$

G₀′ and G₀″ are the storage and loss moduli at 1 rad/s, while n′ and n″ are exponents denoting the frequency dependence of G′ and G″. G₀′ and G₀″ indicate gel rigidity or firmness i.e., the elastic and viscous resistance of the gels. A higher G₀′ and G₀″ indicates higher gel rigidity and higher resistance to deformation. The power law parameters calculated from equations 6 and 7 are presented in Table 2.

TABLE 2
Power law parameter values are obtained by fitting the values of G′
and G″ with angular frequency using equations 6 and 7.

| Sample | G0′ | N0′ | G0″ | N0″ |
|---|---|---|---|---|
| ARG80-60 MIN | 10.08 ± 0.08 ^{b} | 0.109 ± 0.003 ^{cb} | 1.91 ± 0.01 ^{b} | 0.114 ± 0.002 ^{ba} |
| ARG90-60 MIN | 12.42 ± 0.08 ^{a} | 0.104 ± 0.002 ^{ed} | 2.32 ± 0.02 ^{a} | 0.106 ± 0.003 ^{d} |
| ARG100-60 MIN | 7.38 ± 0.02 ^{e} | 0.103 ± 0.001 ^{ed} | 1.35 ± 0.01 ^{e} | 0.108 ± 0.003 ^{d} |
| AIR100-60 MIN | 7.91 ± 0.03 ^{de} | 0.109 ± 0.001 ^{b} | 1.46 ± 0.01 ^{d} | 0.117 ± 0.002 ^{a} |
| DW-60 MIN | 8.47 ± 0.06 ^{dc} | 0.100 ± 0.003 ^{ed} | 1.54 ± 0.01 ^{d} | 0.109 ± 0.002 ^{bc} |
| ARG80-30 MIN | 9.95 ± 0.11 ^{b} | 0.106 ± 0.004 ^{ce} | 1.98 ± 0.01 ^{b} | 0.110 ± 0.002 ^{bc} |
| ARG90-30 MIN | 8.88 ± 0.08 ^{c} | 0.101 ± 0.003 ^{e} | 1.73 ± 0.02 ^{c} | 0.099 ± 0.004 ^{e} |
| ARG100-30 MIN | 7.58 ± 0.04 ^{de} | 0.105 ± 0.002 ^{ce} | 1.42 ± 0.01 ^{e} | 0.109 ± 0.003 ^{bc} |
| AIR100-30 MIN | 6.25 ± 0.01 ^{f} | 0.117 ± 0.001 ^{a} | 1.19 ± 0.01 ^{e} | 0.116 ± 0.002 ^{a} |
| DW-30 MIN | 5.93 ± 0.03 ^{f} | 0.110 ± 0.002 ^{cb} | 1.1 ± 0.01 ^{f} | 0.112 ± 0.002 ^{bc} |

Values are expressed as the mean±standard deviation of three replicates. Alphabets a,b,c,d,e,f within the same column indicate values that are significantly different (p<0.05).

The ARG80 indicates significantly higher (p<0.05) G0′ and G0″ values, when at the heating time of 30 min. The PPI gels prepared by AIR100 and DW samples heated for 30 min have low G0′ values, indicating the weakest gel behavior. The G0″ values of DW are also significantly lowest at the heating time of 30 min.

When the heating time is increased from 30 to 60 min, there is an overall increase in both G0′ and G0″ values of all the PPI gels, indicating that gel rigidity or firmness increases (Table 2 and FIG. 2B). In the case of samples heated for 60 min, ARG90 exhibits significantly higher G0′ and G0″ values, indicating that the rigidity or firmness of ARG90 gels increases more than those of ARG80. In the case of ARG80 heated for 60 min, the G0′ and G0″ values remain statistically similar to those heated at 30 min, indicating that heating time has no impact on the G0′ and G0″ values for ARG80. A similar observation is seen in the case of ARG100 samples, wherein there is no significant impact of heating time in the values of G0′ and G0″. The G0′ and G0″ values of DW gels heated for 60 min are significantly lower than the corresponding values of ARG80 gels heated for 30 min, indicating that ARG80 samples have attained a higher gel strength and viscoelastic properties than DW samples, in half the heating time.

It is also observed that feed gas combinations that include a mixture of argon and air heated at 30 min (ARG90 and ARG80) induce stronger gels with higher G0′ and G0″ values when compared to the feed gases of 100% argon and 100% air (ARG100 and AIR100) heated at 60 min.

This indicates that even within PAMB feed gases, there are some intrinsic factors related to specific reactive species generated by certain gases affecting the viscoelastic properties of PPI gels.

The n′ and n″ exponents corresponding to G0′ and G0″ also differences, but without any statistical significance, other than AIR100-60 min (Table 2). However, for all samples, n′<n″, indicating that the rate of decrease of G′ is lower than the rate of decrease in G″ with a decrease in angular frequency (ω).

Along with RONS, some reactive argon species also contribute to this gelation effect in pea proteins. Bu et al. (2022b) have reported that all reactive species generated as an outcome of cold plasma can induce protein denaturation and form disulfide-linked soluble aggregates, thereby resulting in better gelation properties in pea proteins.

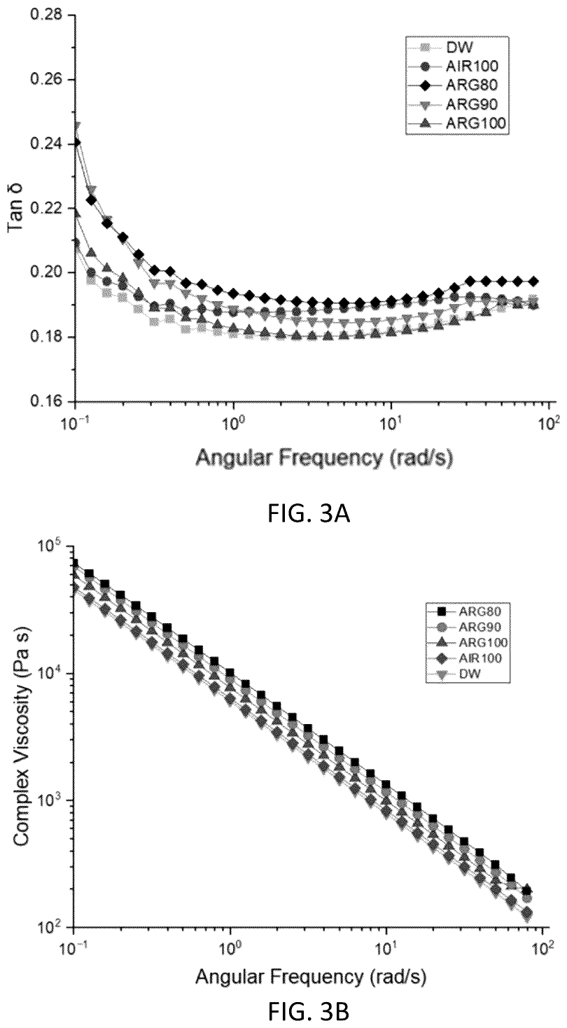

The tan δ values of all PPI gels are observed to be in the range of 0.1-0.3 at all frequencies, as shown in FIG. 3, indicating the prominent elastic behavior of all the samples. Complex viscosity describes the overall resistance to flow exhibited by a viscoelastic material, taking into account both the elastic and viscous components. All samples show a marked decrease in complex viscosity with an increase in frequency, which is an indication of shear thinning behavior corresponding to non-Newtonian fluids. Shear thinning is attributed to the elongation or stretching of molecules with an increase in shear, causing a decrease in molecular entanglements, which in turn enables the sliding between molecules, thereby decreasing the viscosity (Picout and Ross-Murphy, 2003). The complex viscosity of the gels is noted to be higher when PAMB water with argon feed gas is used for gelation, in comparison to distilled water. ARG100 had higher complex viscosity than DW and AIR100. When a combination of air and argon is used, the complex viscosity further increased, with ARG80 showing a higher complex viscosity than ARG90.

These results indicate that the type of feed gas utilized for PAMB generation has an impact on the denaturation temperature of proteins as well as the rheological properties of PPI gels. Since the type of feed gas directly determines the nature of reactive species in PAMB, it is found that various reactive species in each PAMB water are inducing specific rheological properties. This conclusion is also supported by the finding of Bu et al. (2022), who have reported that reactive species, such as O₃, NOₓ, H₂O₂ and OH generated in ACP with air as feed gas can induce enhanced protein solubility and increase in soluble aggregates. It is also noted that the balance between hydrophobicity and surface charges facilitate protein-protein and protein-water interaction, leading to the formation of strong PPI gels.

When analyzing the PAMB gels, it is determined that ARG90 and ARG80 exhibit superior viscoelastic properties compared to both ARG100 and AIR100. This indicates that PAMB produced with a combination of gases (air or argon) in the feed mixture has better gelling properties than PAMB produced by either of these individual gases. This phenomenon is explained in connection with the results of RONS characterization, wherein AIR100 and ARG100 have either the highest or lowest RONS quantities. AIR100 had significantly high amounts of ozone, nitrite, and nitrate but significantly low quantities of H₂O₂. In contrast, ARG100 has a significantly high amount of H₂O₂ but very low quantities of ozone and nitrate. At the same time, ARG80 and ARG90 have considerable quantities of ozone, H₂O₂, and nitrates, indicating the presence of both ROS as well as RNS. It is shown that the presence of both ROS and RNS led to the increase in viscoelastic properties of PPI gels prepared by PAMB water with ARG90 and ARG80 as feed gases. A similar conclusion is reached by Bu et al. (2022), where the authors established that O₃ and OH reactive species are significant in improving the functional properties of PPI. In addition, there are contributions from reactive Ar species and other reactive oxygen species (OH radicals, superoxide anions, and singlet oxygen) on improving the viscoelastic properties of PPI gels. The compressive stress, compressive strain, and Young's modulus of PPI gels prepared by heat gelation at 85° C. for 30 and 60 min are presented in Table 3. These large deformation properties are tested to gain insights regarding the textural properties and the feasibility of 3D printing of PPI gels. The higher the compressive strength, the better the potential gel stability and resistance to failure once printed, especially as the printed object becomes taller in height. Conversely, the higher the compressive strain at break, the more resistant the gel is to fracture. Overall, all gels exhibited an initial stiffening followed by a linear stress-strain response up to maximum stress (and strain at break). The compressive failure is ductile in nature with a slow drop in stress with increasing applied deformation. This latter behavior is important to ensure good printability of the 3D printed gels (i.e., extrusion without line breakage).

The feed gas composition and heating time have a significant impact (p<0.05) on the compressive stress of the PPI gels. After 30 min of heating, compressive stress values of all PPI-PAMB gels except AIR100 gels are significantly different from those of DW gels. After 60 min heating, DW gels have significantly lower compressive stress. All PAMB-PPI gels do not exhibit any significant difference in compressive stress values among each other. It can also be noted that DW gels do not display a statistically significant increase in compressive stress with an increase in heating time from 30 to 60 min (Table 3). In the case of PPI-PAMB gels, ARG100, AIR100 and ARG90 display a statistically significant increase in compressive stress with an increase in heating time from 30 to 60 min, however, the compressive stress of ARG80 remains statistically similar even with the increase in heating time from 30 to 60 min.

Heating time increase from 30 to 60 min also has a significant impact (p<0.05) on the compressive strain of PPI gels heated at 85° C., depending on the feed gas used. Similar to the results in compressive stress, a heating time of 30 min does not result in significantly different compressive strain values among PPI-PAMB gels, while the compressive strain at break values are different from DW gels. With an increase in heating time to 60 min, ARG80 has a significant increase in compressive strain, while all other PPI gels remain statistically similar. A higher compressive strain at the break of a food gel indicates the toughness of the material and its suitability for 3D printing and has been found to correspond to better extrudability and layer adhesion in 3D food printing (Liu et al., 2018). With a higher compressive strain at break, it can be assumed that ARG80 gels heated for 60 min would exhibit properties favorable for extrusion 3D printing. Young's modulus is the resistance of deformation of gels due to the applied load and regarding 3D printing, it indicates the stiffness of 3D printed product. Young's modulus of the PPI-PAMB gels is found to have no significant impact with an increase in heating time or feed gas composition. The overall results of compressive stress and compressive strain of PPI-gels indicate that the heating time of 60 min results in gels with better properties. After 60 min of heating time, all PAMB-PPI gels have higher compressive stress than DW and ARG80 had the highest compressive strain.

TABLE 3
Mechanical properties of PPI gels (Compressive stress, compressive
strain, and young's modulus) gelated at 85° C. for 30
and 60 min, respectively. The data is compared within each column.

| Heat- | | Compressive | Compressive | Young's |
|---|---|---|---|---|
| ing | | stress | strain | modulus |
| time | PPI gels | (kPa) | (mm/mm) | kPa |
| 30 | DW | 2.55 ± 0.61 ^{d} | 0.18 ± 0.01 ^{d} | 16.4 ± 3.0 ^{c} |
| MIN | AIR100 | 2.72 ± 0.08 ^{d} | 0.19 ± 0.00 ^{cd} | 21.9 ± 1.0 ^{bac} |
| | ARG80 | 3.83 ± 0.61 ^{bc} | 0.23 ± 0.01^{cb} | 21.2 ± 2.2 ^{bac} |
| | ARG90 | 4.4 ± 0.20 ^{dc} | 0.21 ± 0.02^{cbd} | 17.3 ± 3.8 ^{c} |
| | ARG100 | 3.81 ± 0.21 ^{dc} | 0.20 ± 0.03^{cd} | 22.1 ± 1 ^{bac} |
| 60 | DW | 2.57 ± 0.44 ^{d} | 0.21 ± 0.01 ^{cbd} | 18.1 ± 5.9 ^{bc} |
| MIN | AIR100 | 3.94 ± 0.40 ^{bac} | 0.22 ± 0.03 ^{cb} | 21.0 ± 1.1 ^{ba} |
| | ARG80 | 4.03 ± 0.81 ^{bac} | 0.28 ± 0.03 ^{a} | 21.6 ± 3.0 ^{bac} |
| | ARG90 | 4.76 ± 0. 88 ^{a} | 0.24 ± 0.02 ^{b} | 24.9 ± 5.6 ^{a} |
| | ARG100 | 4.49 ± 0.55^{ba} | 0.22 ± 0.02 ^{cb} | 24.3 ± 4.1 ^{bac} |

Values are expressed as the mean±standard deviation of three replicates. Alphabets a,b,c,d within the same column indicate values that are significantly different (p<0.05).

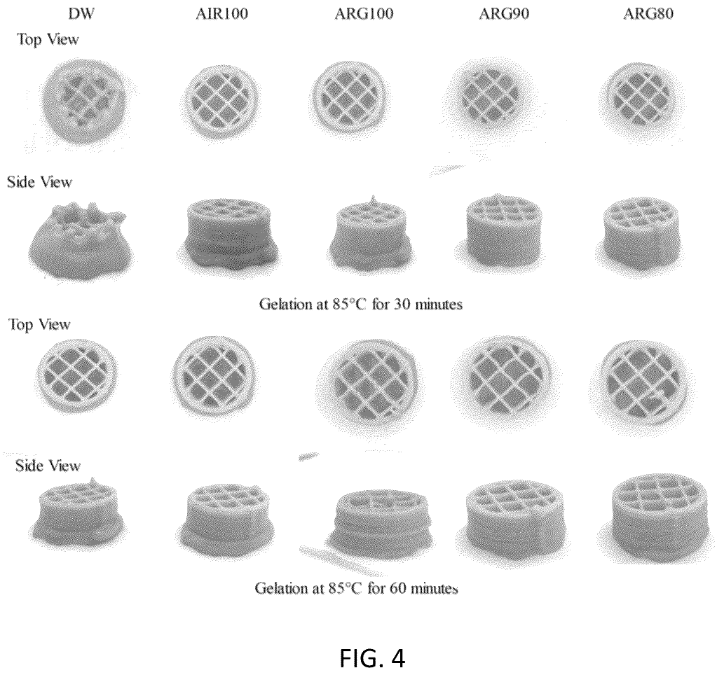

FIG. 4 presents the 3D printed PPI gels made from PAMB water, heated at 85° C. for 30 and 60 min. The native pea protein suspensions are not readily extrudable however, gelation improved the printability of pea protein isolates. Even though all PPI gels could be extruded from the nozzle of the 3D printer, the printing quality varies widely within the samples.

The heat gelation time of 30 min at 85° C. followed by cooling for 30 min considerably improves the extrudability of the PPI. Even though the DW gels produced at this condition are easily extruded from the 3D printer, an overall structural instability is observed, causing the 3D printed shapes to easily cave in and deform. Typical creep behavior of viscoelastic materials, indicating a gradual and time-dependent deformation under a constant applied load, can be observed in the first layer of the extruded PPI gel, causing it to deform and spread immediately upon printing. With more layers depositing on top of each other, the creep of the first layer leads to the distortion of the entire product, causing the 3D printed cylinder to sag and cave in. A distinct lack of adhesion between layers also can be observed here.

When DW is replaced with PAMB water to prepare PPI gels, there is a notable improvement in printability, with 3D printed gels showing holding structure and shape with minimal deformation. It can be noted that there is no caving-in of the top layer, indicating that the top layers remained adhered to the bottom layers. Even though AIR100-30 min and ARG100-30 min samples show marked improvement in printability and structural strength, the creep behavior is markedly observed in bottom layers, as it tends to spread out. It is to be noted that as in the case of DW, the creep behavior of the gel does not lead to total deformation of the sample, as the layers deposited on top of the bottom layer tend to hold shape. It is also found that the layers other than the bottom-most layer do not exhibit creep behavior. A possible reason is the surface tension acting on each layer. In the case of the bottom-most layer, the observed time dependent spreading (creep) is due, at least in part, to the increasing weight of subsequent layers coupled with a smooth bottom surface (i.e., deposition on parchment paper). For all other subsequent layers printed on top of the bottom layer, the surface tension of each layer provides resistance to creep behavior. According to some inventive embodiments, a print bed with a rougher surface or cooling capabilities prevents the first layer from spreading. Similar spreading of the first layer has also been observed in other studies (Lim et al., 2023).

In the case of ARG80-30 min and ARG90-30 min, the printability is improved, with decreased creep behavior of the bottom layers, enabling accurate layer deposition. A slight layer-on-layer adhesion is observed, with printed lines of the final product visible and displaying the layer-over-layer stacking properties distinctively. Moreover, the bottom layers of the gels hold the shape and do not spread out as the height of the printed shape increases, indicating minimal creep behavior in these samples.

With the increase of gelation time to 60 min, an ability to resist the deformation is observed in DW gels. However, the structural stability of 3D printed DW gels is poor, with a display of creep behavior. The base and bottom layers are deformed and spread out, while the top layers led the structure without deformation. A similar creep behavior is seen in the bottom layers of AIR100, with the top layers holding the structure. In the case of ARG100, the creep behavior of the bottom layer is observed as minimal, however, the layer-over-layer deposition is not uniform, indicating a lack of adhesion between layers.

ARG80 and ARG90 gels heated for 60 min display better printability, with smooth extrusion from the nozzle, clearly visible printed lines, and layer-over-layer stacking properties. It is noted that the creep behavior of the bottom layers is the least in these gels in comparison to all other printed gels. These ARG80 and ARG90 gels exhibit better shape retention and structural stability, in comparison to all other gels.

The printability of a food ink is characterized by its ability to adapt to printing processes and deposition without compromising the structural integrity (Jiang et al., 2022). The extrudability, printability and structural strength of 3D printed PPI gels could be correlated to the gelation of pea protein isolates, rheological, and mechanical properties of PPI gels and hence the specific reactive species concentrations in PAMB water. The G′ or G″ values of PPI-PAMB gels at both 30- and 60-min gelation time indicated the elastic nature and the shear thinning behavior of gels, which is the reason why the PPI-gels are extruded smoothly from the nozzle (Lipton, 2017). The highest G0′ & G0″ values are calculated for ARG90 gels, followed by ARG80 gels, heated for 60 min and these samples display the best 3D printability. This explains why the creep behavior is less on ARG90 and ARG80 samples, as a higher G0″ value corresponds to a lower creep behavior, indicating that the material resists deformation. (Kim et al., 2018; Kim et al., 2021).

All PPI-PAMB gels at 60 min heating had higher compressive strengths than DW gels, while ARG8060 min is the most ductile, as indicated by high compressive strain values. Another notable observation is the correlation of concentrations of RONS in PAMB water with the printability of PPI-PAMB gels. The characterization results indicate that both ARG80 and ARG90 had ROS and RONS values ranging between those for ARG100 and AIR100. Regarding the printability of PPI-PAMB gels, it is speculated that the presence of both ROS and RNS is required for the best printing properties in PPI gels.

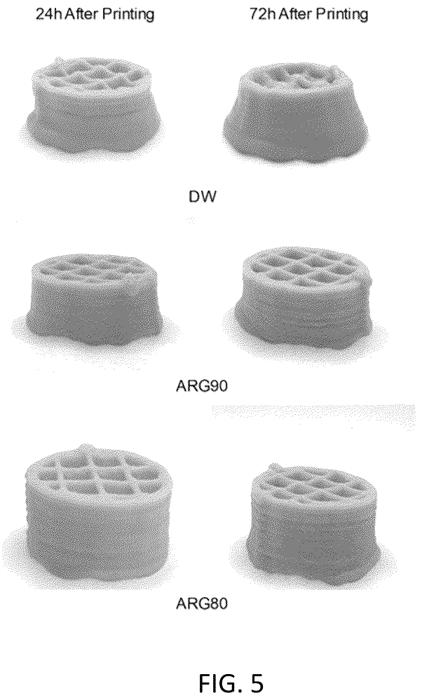

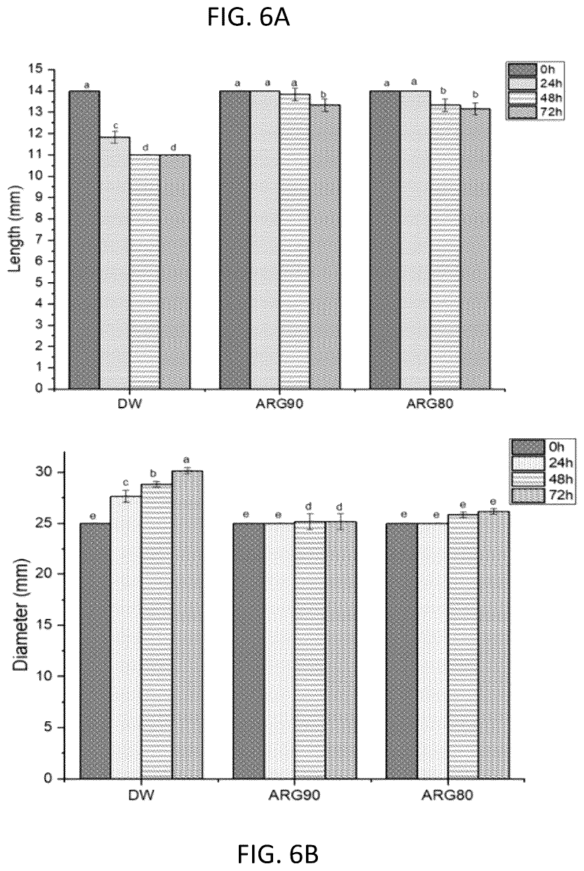

The storage stability of 3D printed PPI gels after 24 and 72 h is illustrated in FIG. 5 and FIG. 6, respectively. The results indicate that 3D printed PPI gels prepared using ARG90 and ARG80 resist deformation after 24 h post-printing storage, with minimal deformation even after 72 h of storage. The 3D printed gels prepared using DW exhibit disintegration within 24 h after printing, with the entire structure caved in at the top by the end of 72 h storage. The dimensions of 3D printed PPI gels prepared using ARG90 and ARG80 are comparable to that of a fresh 3D printed gel even after 24 h of storage. For these 3D printed gels during 48 and 72 h storage, there is only a very slight variation in dimension in comparison to DW gels.

The storage stability of PPI-PAMB gels can also be attributed to the smaller creep behavior of ARG90 & ARG80. With the lowest G0″ for DW, it is evident that these samples would succumb to creep behavior, with deformation over time even when subjected to gravitational forces. In the case of ARG90 and ARG80, a higher G0″ has resulted in lesser creep behaviors, characterized by lesser deformation over time, by gravitational forces.

The results of this storage study demonstrate that 3D printed PPI gels prepared using PAMB have a higher structural stability and resistance to deformation upon storage. This indicates the feasibility of cold plasma application for improving the structural stability and functionality of PPI gels.

Preliminary experiments are performed to prove the application of PAMB to improve 3D printability of other plant proteins i.e., fava bean protein. PAMB is prepared by treating distilled water for 30 min using a plasma jet with argon and air as the feed gas with a ratio of 90:10.

TABLE 4
Viscosity values of fava bean protein gels
prepared by heating at 95° C. for 30 min.

| | |
|---|---|
| PAMB | Control |

| | | | | |
|---|---|---|---|---|
| Viscosity | 151.8 | cP | 145.7 | cP |
| Std Deviation | ±1.4 | cP | ±3.2 | cP |

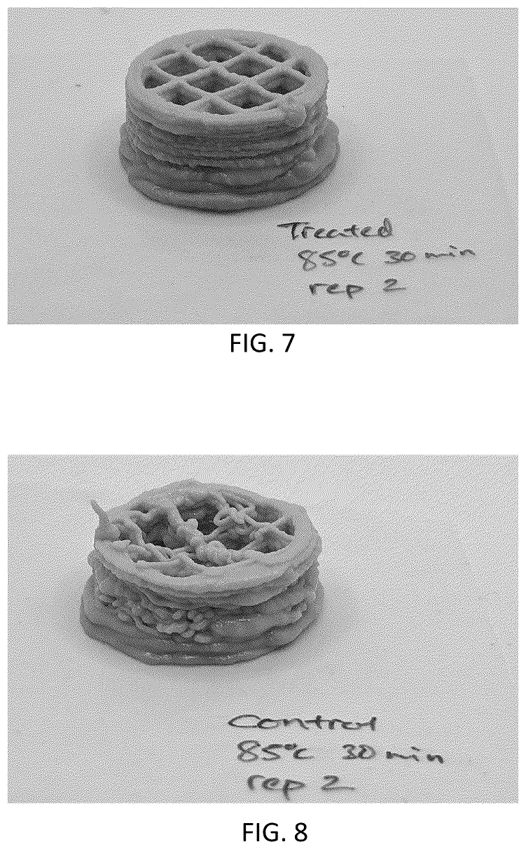

The fava bean protein ink prepared using PAMB exhibits better printability, precision, and structural stability, as shown in FIGS. 7 and 8. Better rheological properties and water holding capacity are observed of the gels prepared by PAMB compared to distilled water.

The present invention is well suited for other biomaterials such as starches, cellulose nanoparticles, lipids etc. to improve their printability by PAMB method for various applications.

A three-dimensional printed article is produced from an inventive biomaterial gel that is applied in a selective manner to create heterogeneities within the article using the FoodBot 3D-Printer detailed above. The heterogeneity being one of composition or a void. In this context, the exterior of a solid article is considered to be a void.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A method of preparing a biomaterial gel for three-dimensional printing, the method comprising:
generating plasma-activated microbubble (PAMB) water by treating distilled water for a first period of time at a first temperature in a plasma reactor with a feed gas;
applying the PAMB water to a biomaterial to prepare a biomaterial suspension;
heating the biomaterial suspension at a second temperature for a second period of time; and
cooling the heated biomaterial suspension at a third temperature for a third period of time to form a biomaterial gel.

2. The method of claim 1 wherein the PAMB water is generated using non-thermal plasma.

3. The method of claim 1 wherein generating the PAMB water includes treating the distilled water continuously.

4. The method of claim 1 wherein the plasma reactor is a bubble spark discharge reactor.

5. The method of claim 1 wherein the first period of time is from 10 to 45 minutes.

6. The method of claim 1 wherein the first temperature is 15° C. to 25° C.

7. The method of claim 1 wherein the feed gas is a mixture of 80/90% argon and 20/10% air.

8. The method of claim 8 wherein the feed gas is provided at a fixed flow rate.

9. The method of claim 1 wherein applying the PAMB water to a biomaterial includes mixing the biomaterial with the PAMB water by stirring to prepare the biomaterial suspension.

10. The method of claim 9 wherein the stirring occurs within 2 minutes of the PAMB generation.

11. The method of claim 9 wherein the biomaterial suspension is stirred for 45 to 90 minutes at room temperature followed by 45 to 90 minutes at 4±2° C.

12. The method of claim 1 wherein the second temperature is 70° C. to 95° C.

13. The method of claim 1 wherein the second time period is 45 to 90 minutes.

14. The method of claim 1 wherein the third time period is from 10 to 45 minutes.

15. The method of claim 1 wherein heating the biomaterial suspension occurs in a hot water bath.

16. The method of claim 1 wherein cooling the heated biomaterial suspension occurs in an ice-water bath.

17. The method of claim 1 further comprising placing the biomaterial suspension in a 3D printer syringe.

18. The method of claim 17 further comprising tapping the 3D printer syringe to remove air bubbles from the syringe.

19. The method of claim 1 wherein the biomaterial is one of a polypeptide, a protein, a plant protein, a pulse protein, a pea protein, or a fava protein.

20. A three-dimensional printed article comprising the biomaterial gel of claim 1 applied in a selective manner to create heterogeneities within the article.
